(19) United States
(12) Patent Application Publication
(10) Pub. No.: US 2016/0293967 A1
(43) Pub. Date: Oct. 6, 2016

(54) CATALYST FOR FUEL CELL, METHOD OF PREPARING SAME, AND MEMBRANE-ELECTRODE ASSEMBLY FOR FUEL CELL INCLUDING SAME

(71) Applicant: SAMSUNG SDI CO., LTD., Yongin-si (KR)

(72) Inventors: Myoung-Ki Min, Yongin-si (KR); Chan-Ho Pak, Yongin-si (KR)

(21) Appl. No.: 14/876,103

(22) Filed: Oct. 6, 2015

(30) Foreign Application Priority Data
Apr. 3, 2015 (KR) 10-2015-0047579

(51) Int. Cl. H01M 4/90; H01M 8/10

(52) U.S. Cl. CPC H01M 4/9016; H01M 8/1004; H01M 4/9075

(57) ABSTRACT

A catalyst for a fuel cell including a material including an iridium ruthenium transition metal oxide, a method of preparing the same, and a membrane-electrode assembly for a fuel cell.

### RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2015-0047579 filed in the Korean Intellectual Property Office on Apr. 3, 2015, the disclosure of which is incorporated herein in its entirety by reference.

### BACKGROUND

1. Field

The disclosure relates to a catalyst for a fuel cell, a method of preparing the same, and membrane-electrode assembly for a fuel cell including the same.

2. Description of the Related Technology

Examples of a fuel cell are a polymer electrolyte membrane fuel cell (PEMFC) and a direct oxidation fuel cell (DOFC). A direct oxidation fuel cell which uses methanol as a fuel is called to be a direct methanol fuel cell (DMFC).

The direct oxidation fuel cell has a lower energy density than the polymer electrolyte fuel cell but an advantage of easy handling of liquid-type fuel, being operated at a low temperature, and requiring no additional fuel reforming processor. The polymer electrolyte fuel cell has an advantage of having high energy density and power.

In the above fuel cell, the stack that actually generates electricity includes several to scores of unit cells stacked in multi-layers. Each unit cell is made up of a membrane-electrode assembly (MEA) and a separator (also referred to as a bipolar plate). The membrane-electrode assembly has an anode (referred to as a fuel electrode or an oxidation electrode) and a cathode (referred to as an air electrode or a reduction electrode) attached to each other with an electrolyte membrane therebetween.

Fuel is supplied to an anode and adsorbed on catalysts of the anode, and then, oxidized to produce protons and electrons. The electrons are transferred to the cathode, a reducing electrode, via an external circuit to the cathode, while the protons are transferred to the cathode through the polymer electrolyte membrane. In addition, an oxidizing agent is supplied to the cathode. Then, the oxidizing agent, protons, and electrons are reacted on catalysts of the cathode to produce electricity along with water.

A gas composition at an anode may have oxygen and hydrogen during start-up/shut-down of the car or a fuel starvation which may increase a voltage at a cathode up to greater than or equal to about 1.6 V when this fuel cell is used for a car.

In this way, when a high voltage is applied to the cathode, carbon used as a carrier of a fuel cell catalyst starts to be corroded and becomes sharply corroded at greater than or equal to about 1 V.

### SUMMARY

Some embodiments provide a catalyst for a fuel cell being capable of preventing corrosion of a carrier and having high activity and stability and thereby improving cell performance.

Some embodiments provide a method of preparing the catalyst for a fuel cell.

Some embodiments provide a membrane-electrode assembly for a fuel cell including the catalyst for a fuel cell.

Some embodiments provide a catalyst for a fuel cell including a material including an oxide represented by Chemical Formula 1:

IrₐRu_{b}M_{c}Oₓ [Chemical Formula 1]

wherein in Chemical Formula 1,

M is Fe, Co, Mn, Cu, Ni, Zn, Ti, V, Cr, Pd, Ag, Cd, In, Sn, Au, Os, W, Re, Rh, or a combination thereof,

a ratio of a/(b+c) is 0.3 to 3.5, a ratio of b/c is 0.5 to 25,

x is an number ranging from 0.5 to 2.

In some embodiments, the oxide may have a shape of a nanoparticle, a nanorod, a core-shell or a combination thereof.

In some embodiments, the oxide may have an average particle diameter (D50) of about 1 nm to about 6 nm.

In some embodiments, the material may further include a carrier supporting the oxide, and the oxide may be included in an amount of about 20 wt % to about 99 wt % based on the total amount of the oxide and the carrier.

In some embodiments, the material may further include SiO₂.

In some embodiments, the material may further include a carrier supporting the oxide and the SiO₂.

In some embodiments, the sum of the oxide and the SiO₂ may be included in an amount of about 20 wt % to about 99 wt % based on the total amount of the oxide, the SiO₂ and the carrier, and the SiO₂ may be included in an amount of about 0.5 wt % to about 7 wt % based on the total amount of the oxide, the SiO₂ and the carrier.

In some embodiments, the carrier may include graphite, denka black, ketjen black, acetylene black, a carbon nanotube, a carbon nano fiber, a carbon nano wire, a carbon nano ball, activated carbon, stabilized carbon, indium tin oxide (ITO), TiO₂, WO, SiO₂, or a combination thereof.

In some embodiments, the catalyst for a fuel cell may further include an active material including a metal, the active material may further include a carrier supporting the metal, and the metal may be included in an amount of about 10 wt % to about 80 wt % based on the total amount of the metal and the carrier supporting the metal.

In some embodiments, the oxide may be included in an amount of 0.5 parts by weight to 10 parts by weight based on the total amount, 100 parts by weight of the active material.

Some embodiments provide a method of preparing a catalyst for a fuel cell that includes mixing an iridium precursor, a ruthenium precursor, and a metal (M) precursor in an atomic ratio of Chemical Formula 1 to obtain a mixture; performing first heat treatment of the mixture; and performing second heat treatment of the first heat-treated mixture to prepare a reaction-deriving material including an oxide represented by Chemical Formula 1.

In the mixing step, SiO₂ may be further added thereto, and the method may further include at least one part of the SiO₂ from the second heat-treated mixture after the second heat treatment.

In the mixing step, a carrier may be further added thereto.

In some embodiments, the first heat treatment may be performed under a hydrogen atmosphere at a temperature of about 150° C. to about 500° C., and the second heat treatment may be performed under an air atmosphere at a temperature of about 250° C. to about 500° C.

Some embodiments provide a membrane-electrode assembly for a fuel cell that includes a cathode and an anode facing each other; and a polymer electrolyte membrane between the cathode and anode, wherein the cathode and the anode respectively includes an electrode substrate and a catalyst layer disposed on the electrode substrate and including the catalyst.

Other embodiments are included in the following detailed description.

The catalyst prevents corrosion of the carrier and itself has high stability, and thereby a fuel cell having improved cell performance may be achieved.

### BRIEF DESCRIPTION OF THE DRAWINGS

FIG. 1 is a schematic view of a membrane-electrode assembly (MEA) for a fuel cell according to one embodiment.

FIG. 2 is an exploded perspective view of a fuel cell stack according to one embodiment.

FIG. 3 is a graph showing a thermogravimetric analysis (TGA) of the catalyst layer according to Example 4.

FIG. 4 is a graph showing voltage-current of the catalyst layers according to Examples 1 to 4 and Comparative Examples 1 to 3.

### DETAILED DESCRIPTION

Hereinafter, embodiments are described in detail. However, these embodiments are only exemplary, and this disclosure is not limited thereto.

As used herein, when specific definition is not otherwise provided, it will be understood that when an element such as a layer, film, region, or substrate is referred to as being “on” another element, it can be directly on the other element or intervening elements may also be present.

A catalyst for a fuel cell according to one embodiment includes a material. Specifically, the material may include an oxide represented by Chemical Formula 1.

### CHEMICAL FORMULA 1

### IrₐRu_{b}M_{c}Oₓ

In some embodiments, the oxide represented by Chemical Formula 1 has high water decomposition activity due to a ruthenium (Ru) element and high voltage stability due to an iridium (Ir) element and thus, may improve durability about carrier corrosion.

In addition, the oxide may promote decomposition of water at a high voltage and generating hydrogen and oxygen, for example, an oxygen evolution reaction (OER). A carrier such as carbon may be corroded by an increased voltage at a cathode when the start-up/shut-down of a car or a fuel shortage, but the oxygen evolution reaction may decompose water instead of corroding a carrier at a high voltage and decrease or prevent the carrier corrosion.

In some embodiments of Chemical Formula 1, M may be Fe, Co, Mn, Cu, Ni, Zn, Ti, V, Cr, Pd, Ag, Cd, In, Sn, Au, Os, W, Re, Rh, or a combination thereof. The oxide including another metal in addition to Ru and Ir has increased oxophilic characteristics and may be easily bound to oxygen and thus, water may be easily decomposed. Accordingly, when the oxide is used for a catalyst for a fuel cell, higher activity may be provided.

In some embodiments of Chemical Formula 1, an a/(b+c) ratio may be about 0.3 to about 3.5, and specifically about 1 to about 3. In addition, a ratio of b/c may be about 0.5 to about 25, and specifically about 1 to about 15. When the oxide having a composition where the atomic ratio of Ir, Ru and M is within the range is used for a catalyst for a fuel cell, high activity and excellent stability may be provided and thus cell performance may be improved.

In some embodiments of Chemical Formula 1, x may be an integer of about 0.5 to about 2, and specifically about 1 to about 2. When the value of x is within the range, stable performance may be obtained without changing the water decomposition activity at a high voltage.

In some embodiments, the oxide may have the shape of a nanoparticle, a nanorod, a core-shell or a combination thereof. In some embodiments, the oxide having the above shape may have high dispersion properties.

In some embodiments, the oxide may have an average particle diameter (D50) of about 1 nm to about 6 nm, specifically about 2 nm to about 5 nm. When the oxide has an average particle diameter within the range, the dispersion properties may be further improved, and thus, high activity may be obtained in its small amount.

In some embodiments, the material may further include a carrier supporting the oxide.

In some embodiments, the carrier may include graphite, denka black, ketjen black, acetylene black, a carbon nanotube, a carbon nano fiber, a carbon nano wire, a carbon nano ball, activated carbon, stabilized carbon, indium tin oxide (ITO), TiO₂, WO, SiO₂, and the like or a combination thereof.

In some embodiments, the stabilized carbon may be formed by heat-treating the ketjen black at about 1500° C. to about 3000° C., for example, at about 2000° C. to about 2800° C. In some embodiments, the stabilized carbon has a surface area ranging from about 50 m²/g to about 700 m²/g, for example, about 70 m²/g to about 400 m²/g.

In some embodiments, the oxide may be included in an amount of about 20 wt % to about 99 wt % for example, about 20 wt % to about 80 wt %, or about 30 wt % to a 70 wt % based on the total amount of the oxide and the carrier. When the oxide is supported within the range, high stability may be secured, and dispersion of a catalyst may be improved.

In some embodiments, the material may further include SiO₂ in addition to the oxide represented by Chemical Formula 1.

In some embodiments, the SiO₂ may be added during synthesis of the material, and remain in a small amount even after being removed through a post process such as base treatment.

In some embodiments, the SiO₂ may play a role of an initiator of initiating the above oxygen evolution reaction. In some embodiments, the initiator initiates the oxygen evolution reaction at a lower voltage and may further lower an initiation voltage. Accordingly, when the SiO₂ is added to the material and remains in a small amount, the oxygen evolution reaction readily occurs at a low voltage and thus, may secure high activity and stability and further prevent corrosion of a carrier.

In some embodiments, the material may further include the oxide and a carrier supporting the SiO₂. The carrier is the same as described above.

In some embodiments, the sum of the oxide and the SiO₂ may be included in an amount of about 20 to about 99 wt % for example, about 20 wt % to about 80 wt %, or about 30 wt % to about 70 wt % based on the total amount of the oxide, the SiO₂ and the carrier

When the oxide and SiO₂ are supported within the range, high stability may be secured, and dispersion of a catalyst may be improved.

In some embodiments, the SiO₂ may be included in an amount of about 0.5 wt % to about 7 wt %, for example, about 1 wt % to about 5 wt % based on the total amount of the oxide, the SiO₂ and the carrier. When the SiO₂ is included within the range, corrosion of a carrier may be further prevented while securing high activity and stability of a fuel cell catalyst.

The material may be prepared in accordance with the following method:

An iridium precursor, a ruthenium precursor, and a metal (M) precursor are mixed in an atomic ratio of Chemical Formula 1 to prepare a mixture, the mixture is first heat-treated and then the first heat-treated mixture is second-heat treated.

In some embodiments, the iridium precursor may be hexachloroiridic acid (H₂IrCl₆), and the like, and the ruthenium precursor may be ruthenium chloride (RuCl₃), and the like. In some embodiments, the metal (M) precursor may be a precursor of a Fe, Co, Mn, Cu, Ni, Zn, Ti, V, Cr, Pd, Ag, Cd, In, Sn, Au, Os, W, Re or Rh metal, and each may be a metal chloride, a metal nitrate, a metal sulfonate, and the like.

In some embodiments, the mixture may further include SiO₂. In this case, the method may further include at least one part of the SiO₂ from the second heat-treated mixture after the second heat treatment.

In some embodiments, the first heat treatment may be performed under a hydrogen atmosphere at a temperature of about 150° C. to about 500° C. In some embodiments, the first heat treatment may be performed under a hydrogen atmosphere at a temperature of about 200° C. to about 400° C. In some embodiments, the second heat treatment may be performed under an air atmosphere at a temperature of about 250° C. to about 500° C. In some embodiments, the second heat treatment may be performed under an air atmosphere at a temperature of about 225° C. to about 300° C.

In some embodiments, the SiO₂ may be removed by using a base such as NaOH, KOH and the like or a HF acid.

According to one embodiment, a catalyst for a fuel cell may include an active material other than the above described material.

In some embodiments, the active material may include a metal.

In some embodiments, the metal may be a platinum-based metal. In some embodiments, the platinum-based metal may include, specifically platinum, ruthenium, osmium, a platinum-M alloy (M is at least one metal selected from Ga, Ti, V, Cr, Mn, Fe, Co, Ni, Cu, Zn, Sn, Mo, W, Rh, Ru, Os and Pd), or a combination thereof. In some embodiments, the platinum-based metal may include, Pt, a Pt—Ru alloy, a Pt—W alloy, a Pt—Ni alloy, a Pt—Sn alloy, a Pt—Mo alloy, a Pt—Pd alloy, a Pt—Fe alloy, a Pt—Cr alloy, a Pt—Co alloy, a Pt—Co—Ni alloy, a Pt—Co—Fe alloy, a Pt—Co—S alloy, a Pt—Fe—S alloy, a Pt—Co—P alloy, a Pt—Fe—S alloy, a Pt—Fe—Ir alloy, a Pt—Co—Ir alloy, a Pt—Cr—Ir alloy, a Pt—Ni—Ir alloy, a Pt—Au—Co alloy, a Pt—Au—Fe alloy, a Pt—Au—Fe alloy, a Pt—Au—Ni alloy, a Pt—Ru—W alloy, a Pt—Ru—Mo alloy, a Pt—Ru—V alloy, a Pt—Ru—Rh—Ni alloy, a Pt—Ru—Sn—W alloy, or a combination thereof.

In some embodiments, the active material may further include a carrier supporting the metal. In other words, the metal may be used alone as the active material or supported by the carrier.

In some embodiments, the carrier supporting the metal may include graphite, denka black, ketjen black, acetylene black, carbon nanotube, carbon nano fibers, carbon nano wires, carbon nano balls, activated carbon, stabilized carbon, indium tin oxide (ITO), TiO₂, WO, SiO₂, or a combination thereof.

When the metal is supported on the carrier, the metal may be included in an amount of about 10 wt % to about 80 wt %, and specifically about 20 wt % to about 65 wt % based on the total amount of the metal and the carrier. When the metal is supported within the range, a fuel cell having high activity may be secured and manufacture of a catalyst layer may be facilitated.

The oxide represented by the Chemical Formula 1 of the material may be included in an amount of about 0.5 parts by weight to about 10 parts by weight, for example, about 1 part by weight to about 7.5 parts by weight based on 100 parts by weight of the active material, specifically the sum of the metal and the carrier supporting the metal. When the oxide in the material is included within the range, a catalyst for a fuel cell may have excellent stability at a high voltage through high water decomposition activity without deteriorating performance of a conventional membrane-electrode assembly in a small amount of a noble metal.

According to one embodiment, an electrode for a fuel cell including the catalyst is provided.

In some embodiments, the electrode for a fuel cell includes an electrode substrate and a catalyst layer supported on the electrode substrate.

In some embodiments, the catalyst layer includes the catalyst, and may further include an ionomer to improve adherence and proton transfer properties of the catalyst layer.

In some embodiments, the ionomer may be a polymer resin having proton conductivity and specifically a polymer resin having a cation exchange group selected from a sulfonic acid group, a carboxylic acid group, a phosphoric acid group, a phosphonic acid group, and derivatives thereof at its side chain. Specifically, the ionomer may be at least one polymer resin selected from a fluorine-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, polyether-etherketone-based polymer, and a polyphenylquinoxaline-based polymer. More specifically, the ionomer may be at least one polymer resin selected from poly(perfluorosulfonic acid), poly(perfluorocarboxylic acid), a copolymer of tetrafluoroethylene having a sulfonic acid group and fluorovinylether, sulfide polyetherketone, aryl ketone, poly(2,2′-m-phenylene)-5,5′-bibenzimidazole, and poly(2,5-benzimidazole).

In some embodiments, the hydrogen (H) ion in the cation exchange group of the polymer resin having proton conductivity may be substituted with Na, K, Li, Cs, or tetrabutylammonium ions. When the H ion in the cation exchange group of the terminal end of the side chain is substituted with Na or tetrabutyl ammonium, NaOH or tetrabutyl ammonium hydroxide may be used during preparation of the catalyst composition, respectively. When the H is substituted with K, Li, or Cs, suitable compounds for the substitutions may be used. Since such a substitution is known to this art, a detailed description thereof is omitted.

In some embodiments, the ionomer may be used singularly or in combination. They may be used along with a non-conductive compound to improve adherence with a polymer electrolyte membrane. In some embodiments, the non-conductive compound may be used in a controlled amount to adapt to their purposes.

Examples of the non-conductive compound may be at least one selected from polytetrafluoroethylene (PTFE), a tetrafluoroethylene-hexafluoropropylene copolymer (FEP), a tetrafluoroethylene-perfluoro alkylvinylether copolymer (PFA), ethylene/tetrafluoroethylene (ETFE), an ethylenechlorotrifluoro-ethylene copolymer (ECTFE), polyvinylidene fluoride, a polyvinylidene fluoride-hexafluoropropylene copolymer (PVdF-HFP), dodecylbenzenesulfonic acid, and sorbitol.

In some embodiments, the ionomer may be included in an amount of about 15 wt % to about 50 wt %, and specifically about 20 wt % to about 40 wt % based on the total amount of the catalyst layer. When the ionomer is included within the range, adherence of the catalyst layer is improved, and proton transfer efficiency is increased.

The electrode substrate plays a role of supporting an electrode and diffusing a fuel and an oxidizing agent into a catalyst layer, so that the fuel and the oxidizing agent can easily approach the catalyst layer.

In some embodiments, the electrode substrates are formed from a material such as carbon paper, carbon cloth, carbon felt, or a metal cloth (a porous film composed of metal fiber or a metal film disposed on a surface of a cloth composed of polymer fibers). The electrode substrate is not limited thereto.

In some embodiments, the electrode substrates may be treated with a fluorine-based resin to be water-repellent to prevent deterioration of diffusion efficiency due to water generated during operation of a fuel cell.

In some embodiments, the fluorine-based resin may be one selected from polytetrafluoro ethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, and a copolymer thereof.

In order to increase reactant diffusion effects between the electrode substrates and catalyst layer, the anode or cathode may further include a microporous layer on an electrode substrate.

The microporous layer generally includes conductive powders with a certain particle diameter. The conductive material may include, but is not limited to, carbon powder, carbon black, acetylene black, activated carbon, a carbon fiber, fullerene, carbon nanotubes, carbon nanowires, carbon nanohorns, carbon nanorings, or combinations thereof.

Some embodiments provide a membrane-electrode assembly for a fuel cell including the electrode for a fuel cell.

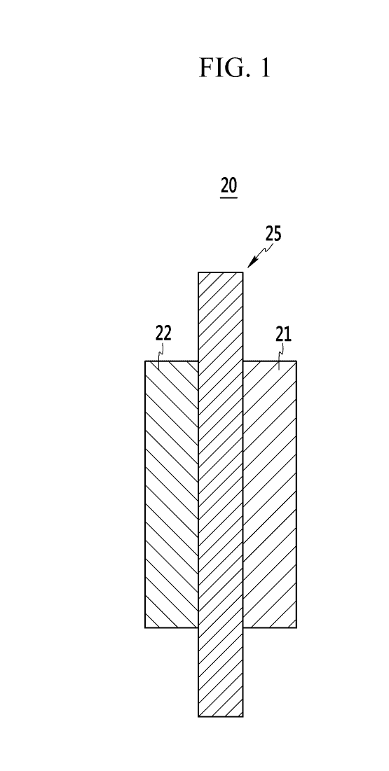

The membrane-electrode assembly for a fuel cell is described referring to FIG. 1.

FIG. 1 is a schematic view of a membrane-electrode assembly (MEA) for a fuel cell according to one embodiment.

Referring to FIG. 1, a membrane-electrode assembly 20 for a fuel cell includes a polymer electrolyte membrane 25 and a cathode 21 and an anode 22 positioned at both sides of the polymer electrolyte membrane 25.

In some embodiments, at least one of the cathode 21 and the anode 22 includes the electrode for a fuel cell.

In some embodiments, the polymer electrolyte membrane 25 is a solid polymer electrolyte having a thickness of about 10 μm to about 200 μm, and functions as an ion exchange of transferring protons produced at a catalyst layer of an anode to a catalyst layer of a cathode.

The polymer electrolyte membrane 25 may be any generally-used polymer electrolyte membrane made of a proton conductive polymer resin. In some embodiments, the proton conductive polymer resin may be a polymer resin having a cation exchange group selected from a sulfonic acid group, a carboxylic acid group, a phosphoric acid group, a phosphonic acid group, and derivatives thereof, at its side chain.

Examples of the polymer resin include at least one selected from a fluorine-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, and a polyphenylquinoxaline-based polymer, and more specific examples may be poly(perfluorosulfonic acid), poly(perfluorocarboxylic acid), a copolymer of tetrafluoroethylene having a sulfonic acid group and fluorovinylether, defluorinated sulfide polyetherketone, aryl ketone, poly[(2,2′-m-phenylene)-5,5′-bibenzimidazole], and poly (2,5-benzimidazole).

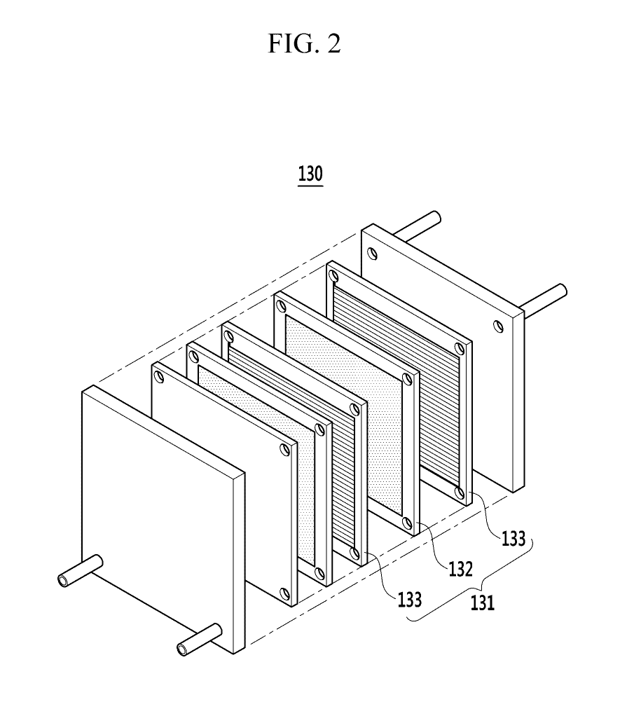

The fuel cell includes a stack where a hydrogen gas electrochemically reacts with an oxidizing agent to generate electrical energy. The stack is described referring to FIG. 2.

FIG. 2 is an exploded perspective view of a fuel cell stack according to one embodiment.

Referring to FIG. 2, the stack 130 includes a plurality of unit cell 131 where an oxidation/reduction reaction of a hydrogen gas and an oxidizing agent occurs to generate electrical energy.

Each unit cell 131 refers to a unit cell to generate electricity, and includes a membrane-electrode assembly 132 where hydrogen gas and oxygen of an oxidizing agent are oxidized/reduced, and a separator (or a bipolar plate) 133 to supply hydrogen gas and an oxidizing agent to the membrane-electrode assembly 132. The membrane-electrode assembly 132 is the same as described above. The separators 133 are arranged on both side of the membrane-electrode assembly 132. Herein, the separators that are respectively located at the most exterior sides of the stack are referred to as, particularly, end plates.

The end plate of the separators 133 includes a first supply tube having a pipe shape for injecting the supplied hydrogen gas, and a second supply tube having a pipe shape for injecting the oxygen gas. The other end plate includes a first discharge tube for discharging the remaining hydrogen gas that does not finally react in the plurality of unit cells 131, to the outside, and a second discharge tube for discharging the remaining oxidizing agent that does not react finally in the plurality of unit cells 131, to outside.

Hereinafter, the following examples illustrate the present embodiments in more detail. However, it is understood that the disclosure is not limited by these examples.

### PREPARATION OF COMPOSITION FOR CATALYST LAYER FOR FUEL CELL

### EXAMPLE 1

A first catalyst (TEC36F52, Tanaka Kikinzoku Corp. Japan)) was prepared by porting 52 wt % of a Pt₃Co alloy with 48 wt % of carbon.

A second catalyst of Ir₈Ru₂FeOₓ (0.5≦x≦2) was prepared by mixing chloroiridic acid (H₂IrCl₆), ruthenium chloride (RuCl₃) and iron nitrate (Fe(NO₃)₃.9H₂O) in an atomic ratio among Ir, Ru and Fe of 8:2:1 to prepare a mixture, first heat-treating the mixture under a hydrogen atmosphere at a temperature of 300° C., and second heat-treating the resultant mixture under an air atmosphere at a temperature of 250° C.

92.6 wt % of the first catalyst was mixed with 7.4 wt % of the second catalyst, and 67 wt % of the catalyst mixture was mixed with 33 wt % of Nafion® (DuPont Co., Ltd., Dupont Co., Ltd. U.S.A), preparing a composition for a catalyst layer. Herein, the Ir₈Ru₂FeOₓ (0.5≦x≦2) was included in an amount of 8 parts by weight based on 100 parts by weight of the first catalyst. The Ir₈Ru₂FeOₓ (0.5≦x≦2) had an average particle diameter (D50) of about 3 nm to 4 nm.

### EXAMPLE 2

A composition for a catalyst layer was prepared was prepared according to the same method as Example 1, except that 80 wt % of a mixture prepared by mixing chloroiridic acid (H₂IrCl₆), ruthenium chloride (RuCl₃) and iron nitrate (Fe(NO₃)₃.9H₂O) in an atomic ratio among Ir, Ru and Fe of 8:2:1, was supported on 20 wt % of stabilized carbon prepared by heat-treating ketjen black at 2250° C., and then first heat treatment was performed.

### EXAMPLE 3

A second catalyst including 94 wt % of Ir₈Ru₂FeOₓ (0.5≦x≦2) and 6 wt % of SiO₂ was prepared by mixing chloroiridic acid (H₂IrCl₆), ruthenium chloride (RuCl₃) and iron nitrate (Fe(NO₃)₃.9H₂O) in an atomic ratio among Ir, Ru and Fe of 8:2:1 to prepare a mixture, adding 80 wt % of SiO₂ to 20 wt % of the mixture followed by first heat treatment, second heat-treating the resultant under an air atmosphere at a temperature of 250° C., and removing a part of SiO₂ with NaOH.

A composition for a catalyst layer was prepared according to the same method as Example 1 except for using the second catalyst.

### EXAMPLE 4

A second catalyst including 76 wt % of Ir₈Ru₂FeOₓ (0.5≦x≦2) and 4 wt % of SiO₂ that were supported on 20 wt % of stabilized carbon was prepared by mixing chloroiridic acid (H₂IrCl₆), ruthenium chloride (RuCl₃) and iron nitrate (Fe(NO₃)₃.9H₂O) in an atomic ratio among Ir, Ru and Fe of 8:2:1 to prepare a mixture, adding 75 wt % of SiO₂ to 20 wt % of the mixture, supporting the resultant on 5 wt % of stabilized carbon prepared by heat treating ketjen black at 2250° C. followed by first heat treatment, second heat-treating the resultant under an air atmosphere at a temperature of 250° C., and removing a part of SiO₂ with NaOH.

A composition for a catalyst layer was prepared according to the same method as Example 1 except for using the second catalyst.

### COMPARATIVE EXAMPLE 1

A composition for a catalyst layer was prepared according to the same method as Example 1 except for not using the second catalyst.

### COMPARATIVE EXAMPLE 2

A second catalyst of Ir₈Ru₃Oₓ (0.5≦x≦2) was prepared by mixing chloroiridic acid (H₂IrCl₆) and ruthenium chloride (RuCl₃) in an atomic ratio between Ir and Ru of 8:3 to prepare a mixture, first heat-treating the mixture under a hydrogen atmosphere at a temperature of 300° C., and second heat-treating the resultant mixture under an air atmosphere at a temperature of 250° C.

A composition for a catalyst layer was prepared according to the same method as Example 1 except for using the second catalyst instead of the second catalyst of Example 1.

### COMPARATIVE EXAMPLE 3

A second catalyst of Ir₈Ru₃Oₓ (0.5≦x≦2) was prepared by mixing chloroiridic acid (H₂IrCl₆) and ruthenium chloride (RuCl₃) in an atomic ratio between Ir and Ru of 8:3 to prepare a mixture, supporting 80 wt % of the mixture on 20 wt % of stabilized carbon prepared by heat treating ketjen black at 2250° C., first heat-treating the mixture under a hydrogen atmosphere at a temperature of 300° C., and second heat-treating the resultant under an air atmosphere at a temperature of 250° C.

A composition for a catalyst layer was prepared according to the same method as Example 2 except for using the second catalyst instead of the second catalyst of Example 2.

### MANUFACTURE OF MEMBRANE-ELECTRODE ASSEMBLY FOR FUEL CELL

Each composition for a catalyst layer according to Examples 1 to 4 and Comparative Examples 1 to 3 was coated on a FEP (fluorinated ethylene propylene) film and sufficiently dried at 90° C. in a convection oven for 5 hours to form a catalyst layer, and the catalyst layer may be used as a cathode catalyst layer consisting of a cathode and an anode catalyst layer consisting of an anode.

The cathode and anode catalyst layers were transferred to a Nafion polymer membrane, and the FEP film was removed, manufacturing a membrane-catalyst layer assembly. The membrane-catalyst layer assembly and a 35BC diffusion layer made by SGL Co., were used to manufacture a membrane-electrode assembly.

### EVALUATION 1

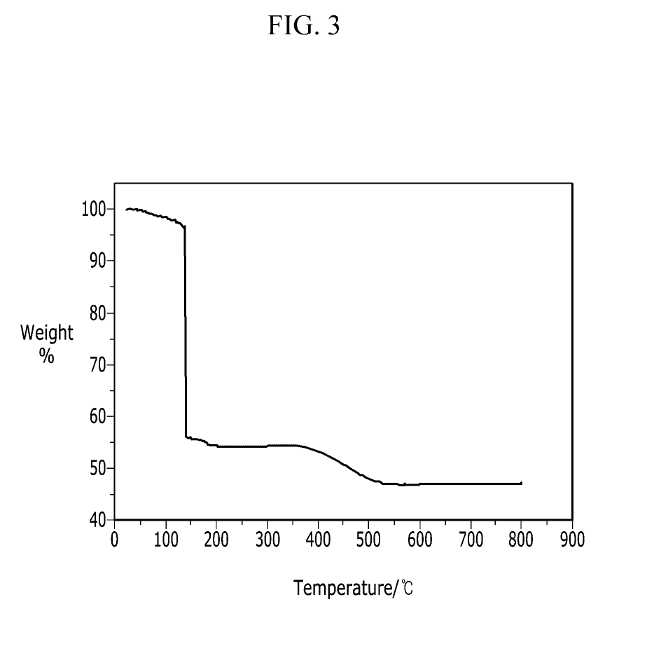

20 mg of the second catalyst prepared in Example 4 was put in a thermogravimetric analysis holder, was heated under an air atmosphere at a rate of 10° C./min up to 800° C., and thermogravimetric analysis (TGA) (RuBoTherm 1920, BoChum Germany) was performed by measuring a weight decrease amount, and the results are shown in FIG. 3.

FIG. 3 is a graph showing a thermogravimetric analysis (TGA) of the catalyst layer according to Example 4.

Referring to FIG. 3, in the case of Example 4, the catalyst amount was decreased at about 165° C. This result may be caused by FeOₓ, and accordingly it was confirmed that the oxide of the material according to one embodiment included additive metal such as Fe in addition to Ir and Ru.

### EVALUATION 2

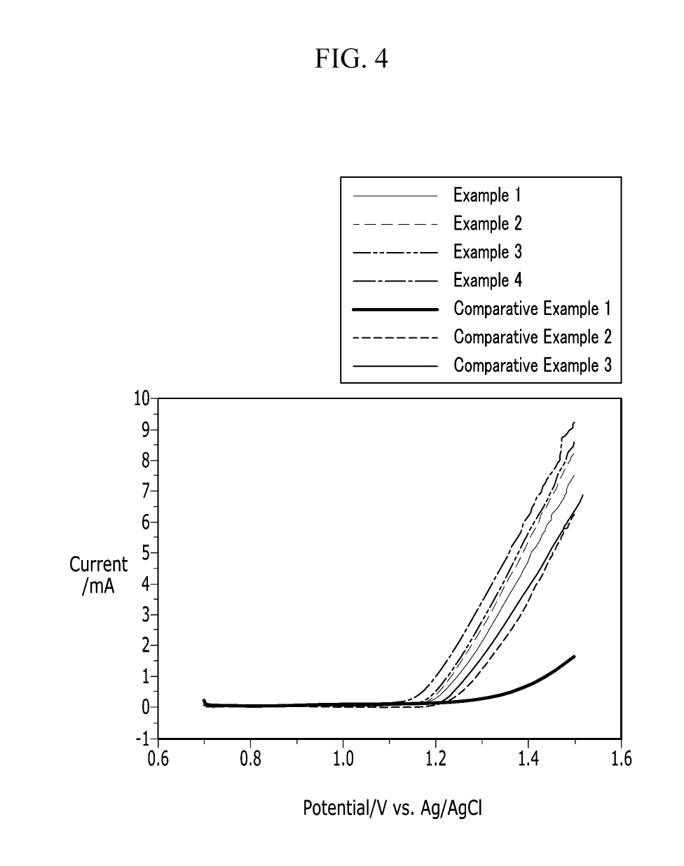

Oxygen evolution reaction (OER) activity of the catalyst layers according to Examples 1 to 4 and Comparative Examples 1 to 3 was evaluated by maintaining a unit battery cell at 65° C., providing a cathode with N₂ of relative humidity of 100% and an anode with H₂ of relative humidity of 100% in cyclic voltammetry (CV) method (Potentiostat SP-300, Bio-Logic Science Instruments, France CLAIX). The scan range of a voltage was expanded up to 0 V to 1.5 V, in which water was decomposed. The results are provided in FIG. 4.

FIG. 4 is a graph showing voltage-current of the catalyst layers according to Examples 1 to 4 and Comparative Examples 1 to 3.

Referring to FIG. 4, Examples 1 to 4 showed sharply increasing current around 1.2 V. Accordingly, an oxygen evolution reaction in which water was decomposed and generated oxygen occurred, and thus, when the material according to one embodiment was used as a catalyst for a fuel cell, water was decomposed before carbon was corroded and thus, increased stability of the fuel cell catalyst.

While this disclosure has been described in connection with what is presently considered to be practical exemplary embodiments, it is to be understood that the disclosure is not limited to the disclosed embodiments and is intended to cover various modifications and equivalent arrangements included within the spirit and scope of the appended claims.

What is claimed is:

1. A catalyst for a fuel cell comprising
a material including an oxide represented by Chemical Formula 1:
IrₐRu_{b}M_{c}Oₓ [Chemical Formula 1]
wherein,
M is Fe, Co, Mn, Cu, Ni, Zn, Ti, V, Cr, Pd, Ag, Cd, In, Sn, Au, Os, W, Re, Rh, or a combination thereof,
a ratio of a/(b+c) is 0.3 to 3.5, a ratio of b/c is 0.5 to 25, and
x has a value ranging from 0.5 to 2.

2. The catalyst for a fuel cell of claim 1, wherein the oxide has a shape of a nanoparticle, a nanorod, a core-shell or a combination thereof.

3. The catalyst for a fuel cell of claim 1, wherein the oxide has an average particle diameter (D50) of about 1 nm to about 6 nm.

4. The catalyst for a fuel cell of claim 1, wherein the material further comprises a carrier supporting the oxide.

5. The catalyst for a fuel cell of claim 4, wherein the oxide is included in an amount of about 20 wt % to about 99 wt % based on the total amount of the oxide and the carrier.

6. The catalyst for a fuel cell of claim 1, wherein the material further comprises SiO₂.

7. The catalyst for a fuel cell of claim 6, wherein the material further comprises the oxide and the SiO₂.

8. The catalyst for a fuel cell of claim 7, wherein the sum of the oxide and the SiO₂ is included in an amount of about 20 wt % to about 99 wt % based on the total amount of the oxide, the SiO₂ and the carrier.

9. The catalyst for a fuel cell of claim 7, wherein the SiO₂ is included in an amount of about 0.5 wt % to about 7 wt % based on the total amount of the oxide, the SiO₂ and the carrier.

10. The catalyst for a fuel cell of claim 7, wherein the carrier comprises graphite, denka black, ketjen black, acetylene black, carbon nanotubes, carbon nano fibers, carbon nano wires, carbon nano balls, activated carbon, stabilized carbon, indium tin oxide (ITO), TiO₂, WO, SiO₂, or a combination thereof.

11. The catalyst for a fuel cell of claim 1, wherein the catalyst further comprises an active material including a metal.

12. The catalyst for a fuel cell of claim 11, wherein the active material further comprises a carrier supporting the metal.

13. The catalyst for a fuel cell of claim 12, wherein the metal is included in an amount of about 10 wt % to about 80 wt % based on the total amount of the metal and the carrier supporting the metal.

14. The catalyst for a fuel cell of claim 12, wherein the oxide is included in an amount of 0.5 parts by weight to 10 parts by weight based on 100 parts by weight of the active material.

15. A method of preparing a catalyst for a fuel cell, comprising
mixing an iridium precursor, a ruthenium precursor, and a metal (M) precursor in order to have an atomic ratio of Chemical Formula 1 to obtain a mixture;
performing first heat treatment of the mixture; and
performing second heat treatment of the first heat-treated mixture to prepare a material including an oxide represented by Chemical Formula 1:
IrₐRu_{b}M_{c}Oₓ [Chemical Formula 1]
wherein,
M is Fe, Co, Mn, Cu, Ni, Zn, Ti, V, Cr, Pd, Ag, Cd, In, Sn, Au, Os, W, Re, Rh, or a combination thereof,
a ratio of a/(b+c) ratio is 0.3 to 3.5, a ratio of b/c is 0.5 to 25, and
x has a value ranging from 0.5 to 2.

16. The method of claim 15, wherein the mixture further comprises SiO₂, and the method further comprises at least one part of the SiO₂ from the second heat-treated mixture after the second heat treatment.

17. The method of claim 15, wherein the mixture further comprises a carrier.

18. The method of claim 15, wherein the first heat treatment is performed under a hydrogen atmosphere at a temperature of about 150° C. to about 500° C.

19. The method of claim 15, wherein the second heat treatment is performed under an air atmosphere at a temperature of about 250° C. to about 500° C.

20. A membrane-electrode assembly for a fuel cell, comprising
a cathode and an anode facing each other; and
a polymer electrolyte membrane between the cathode and anode,
wherein the cathode and the anode respectively comprises:
an electrode substrate and
a catalyst layer disposed on the electrode substrate and comprising the catalyst of claim 1.
